(19) United States
(12) Patent Application Publication
(10) Pub. No.: US 2024/0074012 A1
(43) Pub. Date: Feb. 29, 2024

(54) Smart LED Grow Light

(71) Applicant: Sana-Sar Hovsepian, Sydney (AU)

(72) Inventor: Sana-Sar Hovsepian, Sydney (AU)

(21) Appl. No.: 18/239,046

(22) Filed: Aug. 28, 2023

Related U.S. Application Data
(60) Provisional application No. 63/401,733, filed on Aug. 29, 2022.

(51) Int. Cl. H05B 45/20; A01G 7/04; H05B 47/16

(52) U.S. Cl. CPC H05B 45/20; A01G 7/045; H05B 47/16

(57) ABSTRACT

A smart LED grow light, which is dimmable and provides selectable warm, cool, and daylight outputs which may be controlled by a timer or schedule using a smartphone software application. The combination of a smart phone application and physical grow light creates a smart full spectrum grow light, which is novel and non-obvious in view of the current prior art. A user is provided full control via a smartphone application. In the smartphone application a user can choose from warm, cool, or daylight emission. The light is also dimmable via a built in schedule and timer. The software application for the scheduler interface, a user can select from a simple timer providing basic on/off functionality for a period of time, or a user can select a schedule, which provides a user with the ability to set one or more plans, which can contain a plurality of on/off triggers and multiple on/off periods of varying intensity and light color/wavelength.

### FEDERALLY SPONSORED RESEARCH

Not Applicable

### SEQUENCE LISTING OR PROGRAM

Not Applicable

### TECHNICAL FIELD OF THE INVENTION

The present invention relates in general to grow lights. More specifically, the present invention relates to grow lights for use in providing full spectrum grow lights for indoor plants.

### BACKGROUND OF THE INVENTION

A grow light is an electric light to help plants grow. Grow lights either attempt to provide a light spectrum similar to that of the sun, or to provide a spectrum that is more tailored to the needs of the plants being cultivated. Outdoor conditions are mimicked with varying color temperatures and spectral outputs from the grow light, as well as varying the intensity of the lamps.

Depending on the type of plant being cultivated, the stage of cultivation (e.g. the germination/vegetative phase or the flowering/fruiting phase), and the photoperiod required by the plants, specific ranges of spectrum, luminous efficacy and color temperature are desirable for use with specific plants and time periods.

The current state of grow lights have failed to meet the requirements needed for maximum indoor plant lighting conditions. Current grow lights are made from low quality LED chips which are not capable of providing three in one warm, cool, and daylight colors/wavelengths as well as a full spectrum of color. Current grow lights are not smart enabled with wireless connectivity to mobile electronic devices and thus can not be controlled by a remote timer or scheduler or custom applications for voice applications.

Currently, in order to provide any type of control of a grow light, a user would have to purchase a plug in timer and scheduler in which would need to be plugged into the outlet where a grow light would be plugged in to receive power. To provide voice control or other software or electronic interaction, a second outlet adapter would need to be added such as a smart adapter.

Additionally, to provide brightness control, a dimmer would either need to have been pre-wired to an outlet, or an outlet converted to have a dimmer switch added. Many current LEDs are not able to be controlled with a dimmer switch, having to be operated by an on/off switch and in an on/off manner only, which make even a complex solution involving multiple components unworkable.

Furthermore, current grow lights can not provide growth color/wavelengths and a full spectrum of color, resulting in the need to combine at least a standard grow light with a multi-color smart LED in order to replicate the present invention.

This increased complexity, expense, and potential to create an unsafe wiring environment has created a need for the current invention to provide an indoor lighting solution that is controllable and results in increased growth to indoor plants.

### Definitions

Unless stated to the contrary, for the purposes of the present disclosure, the following terms shall have the following definitions:

Administrators, commonly known as admins or sysops (system operators), are software or system users who have been granted the technical ability to perform certain special actions.

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

A client is a piece of computer hardware or software that accesses a service made available by a server. The server is often (but not always) on another computer system, in which case the client accesses the service by way of a network. The term applies to programs or devices that are part of a client-server model.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

A gateway is a link between two computer programs or systems such as Internet Forums. A gateway acts as a portal between two programs allowing them to share information by communicating between protocols on a computer or between dissimilar computers.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

The Hypertext Transfer Protocol (HTTP) is an application protocol for distributed, collaborative, hypermedia information systems. HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

iOS (originally iPhone OS) is a mobile operating system created and developed by Apple Inc. and distributed exclusively for Apple hardware. It is the operating system that presently powers many of the company's mobile devices, including the iPhone, iPad, and iPod touch.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

An operating system (OS) is software that manages computer hardware and software resources and provides common services for computer programs. The operating system is an essential component of the system software in a computer system. Application programs usually require an operating system to function.

Photosynthetic photon flux density, namely PPFD, informs about the photosynthetic density of photon flux. PPFD means photon flux within that particular area and its unit is written in μmol/s/m2.

Push Notification, Push, or server push, describes a style of Internet-based communication where the request for a given transaction is initiated by the publisher or central server. It is contrasted with pull/get, where the request for the transmission of information is initiated by the receiver or client.

A server is a running instance of an application (software) capable of accepting requests from the client and giving responses accordingly. Servers can run on any computer including dedicated computers, which individually are also often referred to as “the server”.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The present invention is a smart LED grow light, which is dimmable and provides selectable warm, cool, and daylight outputs which may be controlled by a timer or schedule using a smartphone software application. The combination of a smart phone application and physical grow light creates a smart full spectrum grow light, which is novel and non-obvious in view of the current prior art.

A user is provided full control via a smartphone application. In the smartphone application a user can choose from warm, cool, or daylight emission. The light is also dimmable via a built in schedule and timer. This smartphone control enables a user to create a desired aesthetic in their homes, workplaces, or other indoor locations.

The software application for the scheduler interface, a user can select from a simple timer providing basic on/off functionality for a period of time, or a user can select a schedule, which provides a user with the ability to set one or more plans, which can contain a plurality of on/off triggers and multiple on/off periods of varying intensity and light color/wavelength.

During the Inventor's extensive research and testing, results of PPFD (photosynthetic photon flux density) readings were tripled to 288 PPFD compared to inventor's previous models, meaning the present invention results in plants that will potentially absorb over triple the nourishing full spectrum light than before using convention prior art devices.

### BRIEF DESCRIPTION OF THE DRAWINGS

The accompanying drawings, which are incorporated herein and form a part of the specification, illustrate the present invention and, together with the description, further explain the principles of the invention and to enable a person skilled in the pertinent art to make and use the invention.

FIG. 1 is an illustrative image of the grow lamp and smart phone software application for control of a grow lamp as taught by the present invention.

FIG. 2 is a series of illustrative smartphone screens running the software application taught by the present invention for controlling a grow light.

FIG. 3 is an illustration of the scheduler taught by the present invention in the software application that can be programmed to mimic sunlight indoors.

FIGS. 4-5 illustrate the scheduling control of the present invention enabled by software application taught by the present invention.

FIG. 6 illustrates the full spectrum wavelengths that are enabled by the selected LEDS used in the grow light taught by the present invention which can deliver 288 PPFD to an indoor plant.

FIGS. 7-8 illustrate the physical design and structure of the grow light taught by the present invention which is dust and splash proof, as well as capable of delivering warm, cool, and daylight wavelengths in a more efficient manner in one grow light.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figure, it is possible to see the various major elements constituting the apparatus of the present invention.

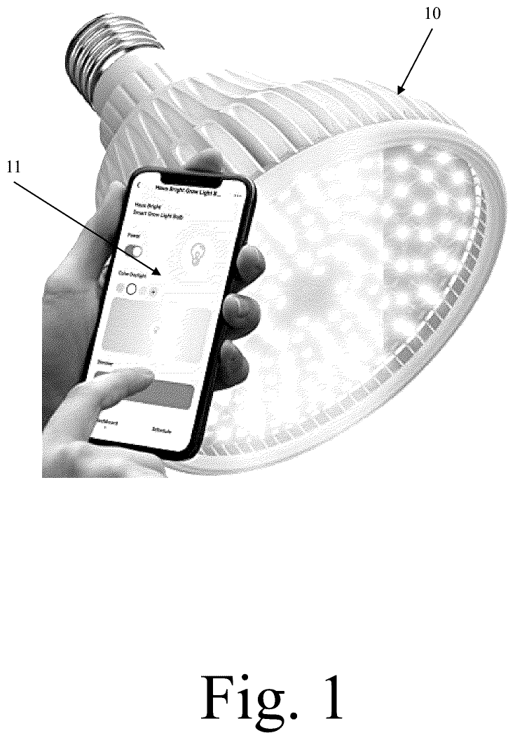

The present invention is a smart LED grow light 10, which is dimmable and provides selectable warm, cool, and daylight outputs which may be controlled by a timer or schedule using a smartphone software application. FIG. 1 is an illustrative image of the grow lamp 10 and smart phone software application 11 for control of a grow lamp 10 as taught by the present invention.

The smart LED grow light 10 taught by the present invention can be constructed from and be embodied by a smart LED strip light, a smart hanging grow light, or a glow light bulb having a light emitting apparatus containing one or more LEDs or LED strips. The smart LED grow light 10 taught by the present invention can be deployed in a mountable fashion for positioning or can be used as a replacement for a standard light bulb that can fit into a standard light bulb sockets such as an E12, E26, and E39.

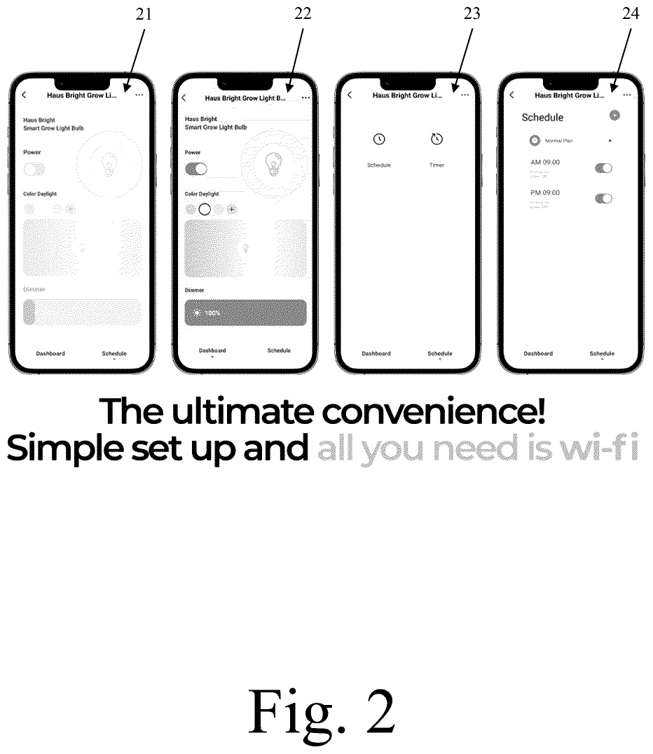

The combination of a smart phone application and physical grow light creates a smart full spectrum grow light 10, which is novel and non-obvious in view of the current prior art. FIG. 2 is a series of illustrative smartphone screens 21, 22, 23, 24 running the software application taught by the present invention for controlling a grow light.

A user is provided full control via a smartphone application 11. In the smartphone application 11 a user can choose from warm, cool, or daylight emission. The light is also dimmable via a built in schedule and timer.

This smartphone control enables a user to create a desired aesthetic in their homes, workplaces, or other indoor locations. The use of a smartphone app 11 connected to the grow lamp 10 component by BLUETOOTH and/or WIFI provides wireless connectivity for the programming and control of the grow lamp. The software application 11 taught by the present invention is provided on both ANDROID and APPLE iOS devices.

As illustrated in the first two illustrative screen images of FIG. 2 showing the dashboard interface, a user can power on or off a connected grow light, a user can select from three preprogrammed colors or wavelengths, those being warm, cool, and daylight, or the user can drag a light logo/image across a displayed spectrum range to adjust the output to a desired, user selectable, wavelength/color.

Now referring to the first two simulated screen images of the software application for the scheduler interface, a user can select from a simple timer providing basic on/off functionality for a period of time, or a user can select a schedule, which will provide the user with the ability to set one or more plans, which can contain a plurality of on/off triggers and multiple on/off periods of varying intensity and light color/wavelength. Additionally, a sliding bar for the setting or selection of brightness/dimming is provided.

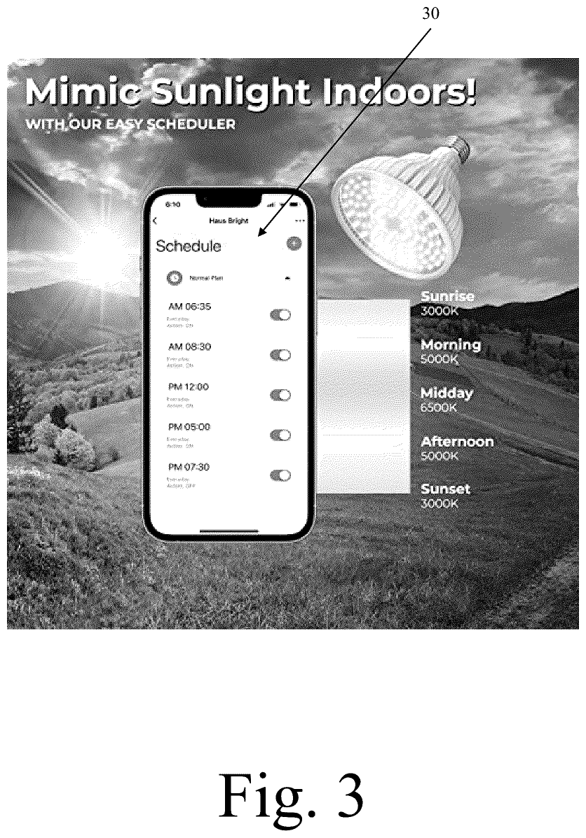

FIG. 3 is an illustration of the scheduler 30 taught by the present invention in the software application that can be programmed to mimic sunlight indoors. FIG. 3 provides an illustration of a schedule which is set to mimic sunlight indoors. The schedule, as shown on the illustrative smartphone application where the schedule starts by turning on the grow light at 6:35 AM, with a sunrise color/wavelength of 3000 k, provides for a morning color/wavelength adjustment to 5000K at 8:30 AM (approximately two hours after the first setting). The morning period runs for approximately three and a half hours and until 12 PM and then a midday simulation setting adjusts the color/wavelength to 6500 k. The midday period runs for approximately five hours until approximately 5 PM when an afternoon setting changes the color/wavelength to 5000 k for another two and a half hours. Finally, at approximately 7:30 PM, a sunset setting adjusts the color/wavelength to 3000 k and shuts off the grow light until the schedule repeats the next morning starting at 6:35 AM.

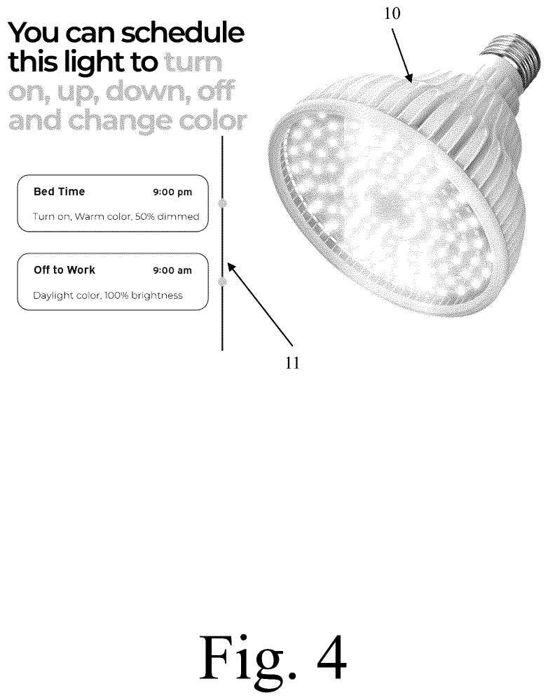

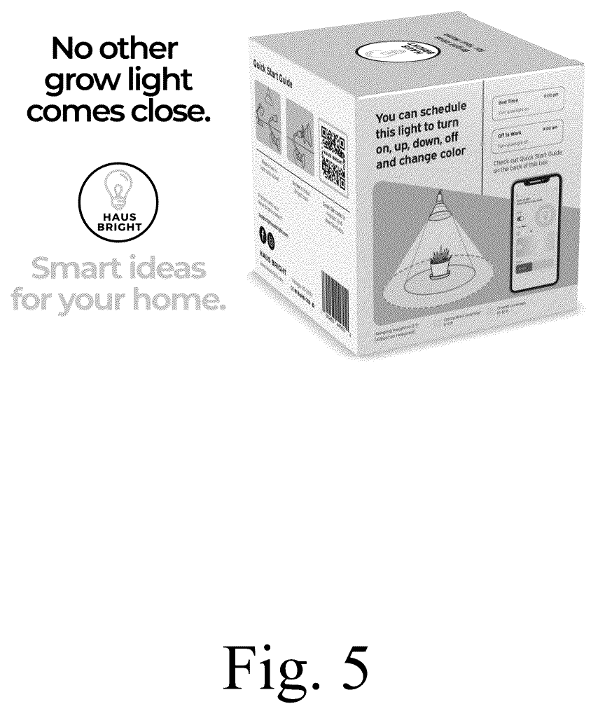

FIGS. 4-5 illustrate the scheduling control of the present invention enabled by software application taught by the present invention. As illustrated in FIG. 4, the scheduler 30 can be used to turn the grow light on and off, and up and down in intensity, as well as changing or adjusting the color/wavelength, from three selective presents corresponding to warm, cool, and daylight wavelengths, as well as providing a selectable map for custom color/wavelength selection(s). The software application 11 allows for the combination of brightness/dimming selection up or down with light color/wavelength selection along the full spectrum of visible color in any combination.

Using the scheduler 30, the grow light 10 can be configured to turn on/off or to make adjustments based on time, adjustment of light color through the full spectrum of colors in additional to warm, cool, and daylight, and intensity by adjusting the brightness up/down or providing a dimmer from full brightness.

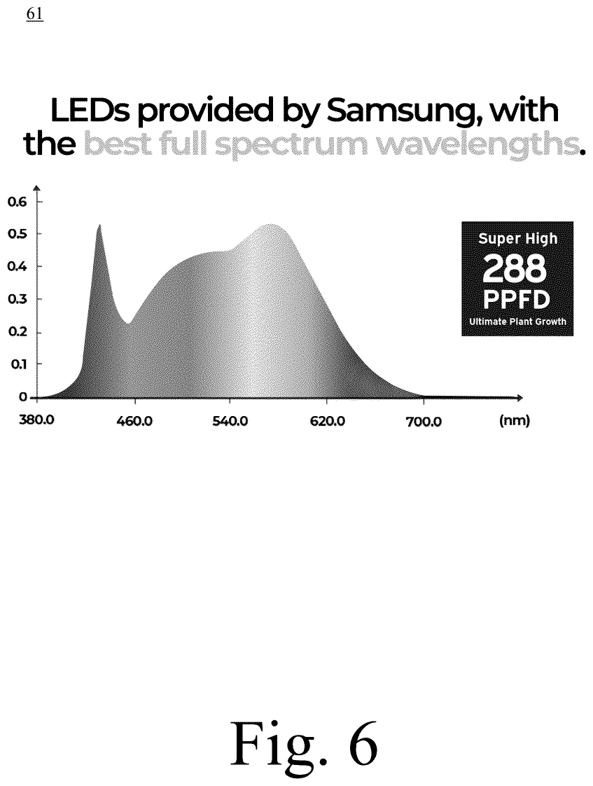

FIG. 6 illustrates the full spectrum wavelengths 61 that are enabled by the selected LEDS used in the grow light 10 taught by the present invention which can deliver 288 PPFD to an indoor plant.

As a result of the present invention, as based on extensive testing by the inventor, users will experience a 210% increase in light absorbed by plants. During the Inventor's extensive research and testing, results of PPFD (photosynthetic photon flux density) readings were tripled to 288 PPFD compared to inventor's previous models, meaning the present invention results in plants that will potentially absorb over triple the nourishing full spectrum light than before using convention prior art devices.

In the physical grow lamp 10 taught and used by the present invention, the LED chips have been upgraded to be 30% brighter and more efficient, still only drawing 20 W. No other grow light 10 on the market or known in the prior art comes close to emitting this level of light energy output at such a low input.

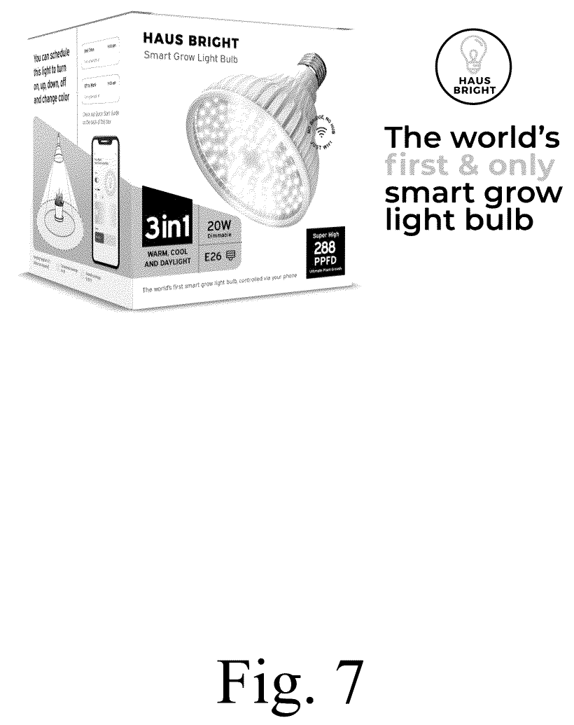

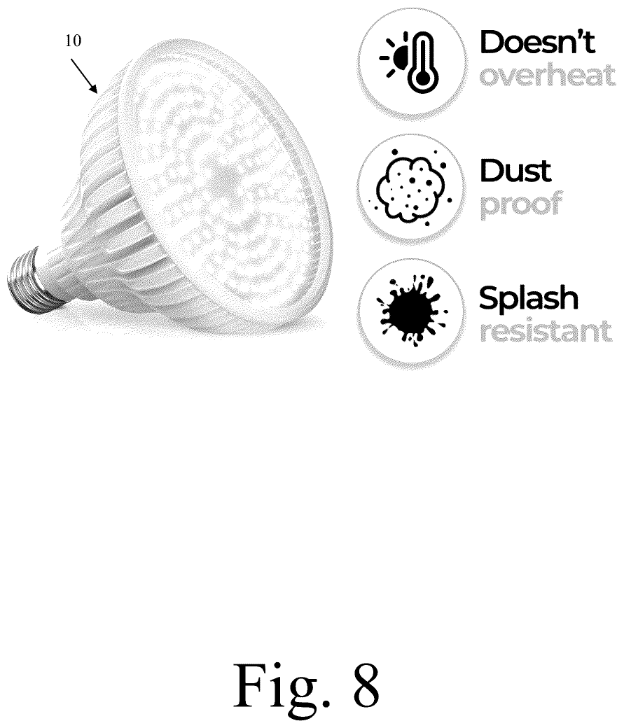

FIGS. 7-8 illustrate the physical design and structure of the grow light taught by the present invention which is dust and splash proof, as well as capable of delivering warm, cool, and daylight wavelengths in a more efficient manner in one grow light.

The grow light 10 of the present invention avoids the common overheating issues of prior art devices and has a resulting extended life as a result of its reduced overheating issues.

Additionally, the grow light 10 has a built-in lens cover that protects the LEDs and makes the full spectrum led grow light 10 splash proof and dust proof.

The software system is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A smart LED grow light, comprising:
one or more LEDs;
a dimmer switch for the one or more LEDs; and
a selectable switch for colors/wavelengths.

2. The device of claim 1, wherein
the selection switch provides selectable warm, cool, and daylight outputs.

3. The device of claim 2, further comprising
a controller providing a timer for controlling the one or more LEDs.

4. The device of claim 3, further comprising
a controller providing a scheduler for controlling the one or more LEDs.

5. The device of claim 4, further comprising
wireless connection between the grow light and a smartphone or mobile device; and
a smartphone software application enabling control of the grow light.

6. The device of claim 5, wherein wireless connectivity provides for the programming and control of the grow lamp.

7. The device of claim 6, wherein via the smartphone software application
a user can choose from warm, cool, or daylight emission; and
the grow light is dimmable via the built in schedule and timer.

8. The device of claim 7, wherein
the smartphone control enables
powering the grow light on or off;
selecting from preprogrammed colors or wavelengths.

9. The device of claim 8, wherein
the preprogrammed colors or wavelengths are warm, cool, and daylight.

10. The device of claim 6, wherein the smartphone control enables
selecting colors or wavelengths by dragging a light logo/image across a displayed spectrum range to adjust the output to a desired, user selectable, wavelength/color.

11. The device of claim 10, wherein the scheduler interface enables
a user can select from a simple timer providing basic on/off functionality for a period of time, or
a user can select a schedule,
which will provide the user with the ability to set one or more plans, and
which can contain a plurality of on/off triggers and multiple on/off periods of varying intensity and light color/wavelength.

12. The device of claim 6, wherein the scheduler interface enables
a sliding bar for the setting or selection of brightness/dimming.

13. The device of claim 11, wherein
the scheduler is programmed to mimic sunlight indoors.

14. The device of claim 4, wherein
the software application allows for the combination of
brightness/dimming,
selection up or down, and
light color/wavelength selection along the full spectrum of visible color in any combination.

15. The device of claim 11, wherein using the scheduler
the grow light is configured to turn on/off, or
to make adjustments based on time,
adjustment of light color through the full spectrum of colors in additional to warm, cool, and daylight, and
intensity by adjusting the brightness up/down or providing a dimmer from full brightness.

16. The device of claim 1, further comprising
a built-in lens cover that protects the one or more LEDs and makes the grow light splash proof and dust proof.

17. The device of claim 1, wherein the smart LED grow light is constructed from
a smart LED strip light,
a smart hanging grow light, or
a glow light bulb having a light emitting apparatus containing one or more LEDs or LED strips.
